(19) United States
(12) Patent Application Publication
(10) Pub. No.: US 2012/0024417 A1
(43) Pub. Date: Feb. 2, 2012

(54) Bellows-Type Reservoir For Microsystems

(75) Inventors: Thomas Voit, Hilden (DE); Bruno Monschau, Solingen (DE)

(73) Assignee: QIAGEN GMBH, Hilden (DE)

(21) Appl. No.: 13/130,214

(22) PCT Filed: Nov. 13, 2009
(86) PCT No.: PCT/EP2009/065081

§ 371 Date: Oct. 7, 2011

(30) Foreign Application Priority Data
Nov. 26, 2008 (EP) 08169958.9

(51) Int. Cl. B65B 3/04; B67D 7/06

(52) U.S. Cl. 141/1; 222/81

(57) ABSTRACT

The invention relates to a storage and dispensing vessel for microsystems and to a method for storing and dispensing a liquid. It is the object of the invention to be able to store a liquid with volatile and/or creeping substances in very small vessels over many months, preferably over at least one year, and to be able to dispense it automatically with comparatively little technical effort. For accomplishing this object, a bellows configured as a vessel is provided which is sealed, preferably welded, in an air-tight and liquid-tight manner once the bellows vessel has been filled. This bellows vessel at the same time serves as a dispensing vessel. The vessel can be emptied automatically with relatively simple means. For this purpose, it is, for example, clamped into a device which compresses the bellows, namely in the direction of a hollow needle—also referred to as cannula or hypodermic needle—or of a comparable means. In the process, the hollow needle or the comparable means pierces a vessel wall. The vessel is then automatically emptied via the hollow needle or the comparable means.

The invention relates to a storage and dispensing vessel used in a microsystem and to a method for storing and dispensing a liquid to be used in a microsystem. A microsystem is a device with which small quantities of liquid are handled, for example in order to carry our chemical or biological analyses. Therefore, such a microsystem comprises channel ducts with small diameters. Diameters of no more than 1 mm, in particular of no more than 150 μm, are customary.

Buffer solutions are used in an analysis of samples or the purification of cellular components, genetic material etc. from a sample in the field of biotechnology. On the one hand, the buffer solutions regularly contain alcohol, for example ethanol. Moreover, such buffer solutions can contain creeping substances, for example salt solutions.

The problem with these constituents of a buffer solution is that they require a tight vessel if the buffer solution is stored. For alcohols are highly volatile, and creeping substances can easily escape from a vessel. In particular at higher temperatures which may occur in the summer or in the tropics, the volatility of alcohol is a particular problem.

Buffer solutions for microsystems are only required in small quantities of, for example, only one milliliter. Since only very much larger amounts starting at one liter can be produced economically, there is the need to fill a produced quantity of buffer solution of, for example, one liter into very small vessels of, for example, one milliliter. Since some buffer solution are only rarely required, the vessels into which the quantity produced has been filled for storage purposes must be made in such a way that storage is possible over several months and even years.

From WO 2005/0022729 A1, it is known to store a buffer solution or other liquids required for analyses in a syringe comprising a cylindrical vessel and a plunger that is movably disposed therein. The outlet opening of the syringe is sealed with a ball. Moreover, the document discloses a device by means of which the contents of the syringe can be withdrawn in an automated and dosed manner.

Basically however, a syringe is not sufficiently tight to allow very long storage times. Even though such syringes are stored preferably cool at temperatures of, for example, 4° C., in order to extend the storage time, it is not possible to achieve storage times of, for example, two years. Moreover, storing a syringe at 4° C. is relatively expensive because cooling chambers have to be provided for storage.

If the desired storage life cannot be accomplished with syringes, then according to the prior art a buffer solution is alternatively filled into a vessel which is subsequently sealed by welding or sealing. In case of application, a defined quantity is withdrawn from such a welded vessel using a syringe and then dispensed again in a defined manner. Such a process is comparatively complicated. A withdrawal and dispensing using a syringe can be carried out automatically only with a disproportionally high technical effort.

A device for receiving and dispensing saliva is known from DE 197 48 331 C1. A saliva sample is received by a bellows configured as a vessel. By compressing the bellows, a sample taken up previously is dispensed again. The vessel known therefrom is neither intended nor suitable for storing solutions provided with volatile or creeping substances over long periods of time of at least several months.

From DE 38 00 667 C2 it is known to use a bellows for the dosed dispensing of a relatively large fluid quantity.

DE 199 22 285 A1 describes the use of a bellows as a sample vessel. Two lids are provided for sealing the two open ends of the bellows. The two lids can be membranes or foils that can be pierced with a hollow needle for a filling process or the withdrawal of a sample. A lid of a vessel constitutes a weak point with regard to tightness. The bellows known from DE 199 22 285 A1 is to be sealed with two lids so that the risks with regard to tightness that accompany one lid double. The vessel known from DE 199 22 285 A1, also for this reason, is not very suitable for storing volatile and/or creeping substances therein over many months.

A bellows-type vessel which is sealed with a closure cap that can be placed thereon is apparent from DE 197 48 331 C1. The vessel serves for receiving saliva therein and dispensing it therefrom. Since the closure cap is merely placed on the vessel, it is incapable of sealing the vessel particularly reliably. The vessel is neither intended nor suited for storing therein volatile and/or creeping substances over many months.

A bellows-type vessel with a screw-on lid is apparent from EP 0 333 075 A2. The opening of this vessel is not sealed in such a way that volatile and/or creeping substances could be stored therein over many months.

Moreover, it is known from the prior art to glue a foil to the edge of the opening of a vessel in order thus to seal an opening. Liquid can escape from a vessel thus sealed with relative ease because the liquid only needs to penetrate a narrow bead of adhesive. This type of closure is not well suited for a permanent and reliable storage of a liquid.

It is the object of the invention to be able to store a liquid with volatile and/or creeping substances in very small vessels over many months, preferably over at least one year, and to be able to dispense it automatically with comparatively little technical effort.

For accomplishing this object, a bellows configured as a vessel is provided which is sealed, preferably welded, in an air-tight and liquid-tight manner once the bellows vessel has been filled. This bellows vessel serves as a storage vessel and at the same time as a dispensing vessel. The vessel can be emptied automatically with relatively simple means. For this purpose, it is, for example, clamped into a device which compresses the bellows, namely in the direction of a hollow needle—also referred to as cannula or hypodermic needle—or of a comparable means. In the process, the hollow needle or the comparable means pierces a vessel wall or the lid of the vessel. In contrast to document DE 199 22 285 A1, the vessel according to the invention thus only has one lid, which reduces problems with regard to tightness. The vessel is then automatically emptied via the hollow needle or the comparable means. Since emptying only requires the generation of a linear movement it is technically relatively simple to enable automatic emptying. In particular in contrast to the vessel known from EP 0 333 075 A2, the vessel according to the claims comprises no further chambers on the inside, and in contrast to the vessel known from DE 197 48 331 C1 a porous part that can be pressed out.

Though bellows are used for dosing purposes as a part of a dispensing vessel according to the prior art, such vessels, however, are filled only just before application. They are therefore not used as a storage vessel in order to store therein a fluid contained therein over several months or even, for example, two years. For the reasons mentioned in the introduction, the vessels known from the prior art are not intended for this purpose, and are thus also not sealed in a suitably tight manner. Vessels with a bellows which are known from the prior art are therefore, in particular, not welded shut or sealed fluid-tight in a comparable manner. In particular, the vessels known from the prior art provided with a bellows generally do not have volumes of maximally 2 ml, preferably maximally 1 ml. If the vessel volume becomes too large and at the same time relatively long, the bellows becomes too unstable to be able to empty the vessel reliably using technically simple means. If the diameter is chosen to be large enough to obtain vessel volumes of substantially more than 2 ml, it is difficult to dispense a predetermined quantity in a dosed manner from the bellows-type vessel using simple technical means. Larger fluctuations in the dosing process have to be accepted. A dosage that is too inaccurate is undesirable or at least very disadvantageous in the purification of samples. Moreover, the consequence of a large diameter is that the vessel is hardly suitable for use in microsystems for reasons of space, because a microsystem is built as small as possible and thus little space is available for connecting one or more vessels with the microsystem. Therefore, a volume of maximally 1 ml has been found to be particularly expedient. Up to such a volume and smaller, the required stability of the bellows is, on the one hand, ensured, even if it is made from plastic and completely forms the lateral vessel walls. On the other hand, such a bellows can be closed down or compressed as far as possible in order to be able to dispense the buffer solution or the fluid otherwise contained therein with an accuracy of +/−5%, namely in an automated manner using the above-described technical means.

Compared with a tube, a bellows has the advantage that the vessel can be emptied in a defined manner with comparatively simple technical means. Compared with a syringe in which a plunger is moved in a cylindrical vessel for emptying, a bellows-type vessel within the meaning of the present invention has the advantage to be able to ensure a seal towards the outside in an improved manner. Considerably longer storage times are thus made possible.

In one embodiment of the invention, such a bellows-type vessel has a bottom region and an opening region. The bottom region is provided with a depression or a pin reaching into the inside of the vessel. The wall region between the bottom region and the opening region is completely configured as a bellows. If the bellows is compressed completely, there remains a distance between the bottom region and the opening region because the bellows cannot be compressed down to 0 mm. In this embodiment of the invention, the depression or pin now extends in the direction of the opening region and ideally reaches it when the bellows has been compressed in the maximally possible manner. It is thus accomplished that the vessel can be emptied commensurately more completely when the opening region is pierced with a hollow needle or a comparable means.

If the bottom region has a depression, then this depression can be used for clamping the vessel in a device for automatic emptying with particular ease. A plug, pin or bolt provided in the device can then be pushed into the depression. In this way, the bellows is securely held in such a dispensing device for automatic, dosed emptying in a suitable manner and is guided securely during the compression of the bellows.

In one embodiment, the opening region of the bellows-type vessel preferably comprises a neck. The neck serves as a guide for the hollow needle. The vessel can thus be held and clamped reliably and simply, at the side of the opening region, in a technically simply designed device for automatic, dosed emptying. The above-mentioned pin or the above-mentioned depression in the bottom region is in this case dimensioned such that the pin or depression reaches the neck, or even reaches into the neck.

Though a neck region with an inner membrane is already known from DE 199 22 285 A1, however, the internal diameter of the neck does not correspond to the external diameter of the hollow needle known therefrom, so that the neck is incapable of guiding the needle in the sense of the present invention. Instead, the external diameter of the needle is many times smaller than the internal diameter of the neck.

Preferably, the aforementioned neck transitions into a laterally outwardly protruding collar. A tool can then reach behind the collar and press against the lid, and weld or glue the lid to the collar in the process. Thus, this geometry makes it possible to fill the vessel via the neck and to subsequently seal it fluid-tight in a simple manner by welding. The vessel is then completely sealed towards the outside by a substance-to-substance bond.

For this purpose, the lid with which the vessel is sealed in a fluid-tight manner has a depression or a pin in the direction of the inside of the vessel. The dead volume, for example in the neck region, is thus further reduced.

The pin or depression of the lid can be provided alternatively or additionally to a pin or depression in the bottom region in order to reduce dead volumes. The diameter of the webs or depressions is preferably selected in such a manner that the webs or depressions are closely adjacent to the bellows in order thus to further minimize disadvantageous dead volumes.

Though welding is known in the prior art, but since a person skilled in the art had not thought of using such a vessel for a very long-term storage, he also did not think of welding the lid to the vessel. He therefore preferred other options of sealing an opening of a vessel by means of a lid.

The collar or the neck of the vessel in one embodiment of the invention are seated in a recess in the device for automatic dispensing and are thus reliably fixed. At the same time, a, for example, round, hollow needle consisting of plastic or metal, which is preferably chamfered in the direction of the vessel in order to be able to easily pierce the lip when the contents of the vessel are to be dispensed, extends into this recess of the lid. After the lid has been pierced, the buffer solution or the fluid otherwise contained therein can drain off through the round, tubular hollow needle.

In one embodiment of the invention, the closure or lid of the vessel has, on an inner wall of a depression into which the needle is pushed, one or more latching projections. The needle is thus guided in the depression very accurately and reliably without having to overcome large friction forces in the process. Operating errors and the like are thus avoided particularly reliably.

Preferably, such a latching projection is dimensioned in such a way that it serves as a stop for the hollow needle when the vessel is clamped of fixed in a device for automatic emptying or for automatic dispensing. In that case, the needle first hits the latching projection and thus a certain resistance. It is thus avoided that the needle pierces the closure prematurely. Only if greater force is exerted can the needle pass the respective latching projection and pierce the closure or lid in the then intended manner.

In one embodiment of the invention, the latching projection and the needle are adapted to each other in such a way that when the stop is reached, the latching projection at the same time serves as a seal in order to thus create a liquid-tight connection between the needle and the vessel. Instead of a projection, the vessel can be provided with a, for example, annular depression into which a protruding, in particular annular bead engages which is provided at the outer circumference of the needle.

In the bottom region of a clamped vessel, the device for automatic emptying can comprise a tappet or pin which reaches into a recess at the bottom of the vessel and which then exerts the force required for compressing the bellows for emptying. However, other options for compressing the vessel are also available. It is possible, for example, that, viewed from the side of the needle, the vessel is compressed and the needle is thus moved upwards in this connection when the vessel is fixed with the outlet opening facing downwards.

In such a dispensing device for automatically emptying the vessel a bellows-type vessel merely has to be inserted into the device. Then, it is compressed in the one or the other manner described, and the buffer solution and the like is thus dispensed in a dosed manner. Compared with the prior art, only relatively little effort is therefore required in order to be able to dispense, for example, a buffer solution in an automatic and dosed manner. A withdrawal of the buffer solution from a storage vessel is dispensed with.

The dispensing device can comprise several such needles and tappets and the like in order to be able to simultaneously clamp and empty several vessels. In that case, however, emptying can take place individually, one after the other, vessel by vessel, if the corresponding bellows-type vessels have been inserted into the dispensing device.

Injection blow molding can be used for producing such vessels. For this purpose, a blank mold is first produced by injection molding. This blank mold is then brought into a final form which has the shape of a bellows. The blank mold is heated and then the mold is blown into in order to thus blow the then heated plastic into the actual shape.

Alternatively a multi-component injection molding process is carried out. The individual regions of the bellows-type vessel are thus injection-molded section by section. In the process, different plastic materials can be used as needed.

In one embodiment of the invention, the closure is immediately injection-molded within the context of such an injection-molding process. The vessel is then filled from the bottom region and the bottom is subsequently welded or glued shut. Alternatively, the actual outlet opening can be used for filling, and then a closure is welded on, as was already indicated. In this manner, vessels are provided which are completely sealed through substance-to-substance bonds.

In the drawings:

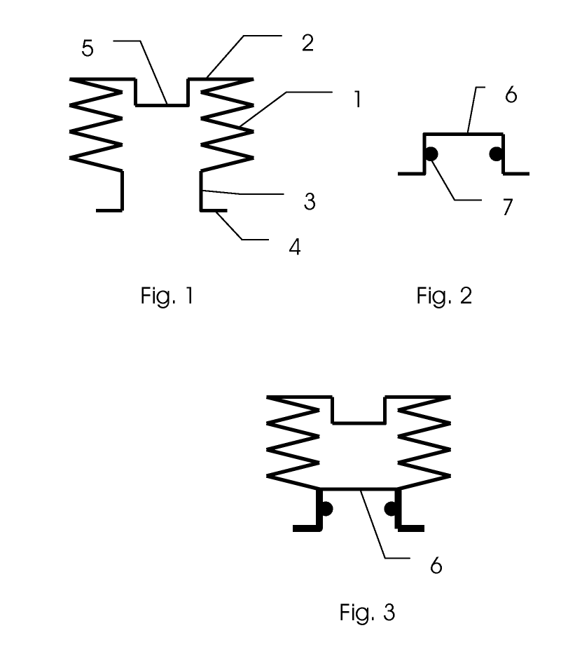

FIG. 1: shows a vessel with a bellows FIG. 2: shows a closure for the vessel with a bellows FIG. 3: shows a sealed vessel with a bellows

FIG. 1 shows a section through a vessel with a volume of 1 ml with a bellows 1, a bottom region 2 and an opening region formed by the neck 3. The neck transitions into a laterally outwardly protruding collar 4. The bottom region is provided with a depression 5. A tappet, pin or the like of a device for automatically emptying the vessel can be plugged into the depression 5 in order to clamp the bottom region 2 into such a device and to guide the bottom during the compression of the bellows. Moreover, the depression 5 contributes to emptying the vessel as completely as possible for the above-mentioned reasons. In particular, the vessel shown in FIG. 1 is made in one piece from plastic in order to minimize problems relating to tightness.

A section through a vessel or lid associated with the vessel is shown in FIG. 2. For reasons that were also already mentioned, the lid comprises a depression 6 and a latching projection 7. The annular edge area of the lid is welded or glued to the collar 4 in order thus to reliably seal the vessel tightly. FIG. 3 shows the sealed vessel. A hollow needle pierces the depression 6 of the lid for emptying purposes. The bellows is then compressed completely. Typically, such a vessel can be emptied by 80% with an accuracy of +/−5%. In this sense, a sufficiently accurate dosage of the quantity of dispensed fluid is successfully accomplished.

The vessel and the lid in particular consist of plastics, for example of polypropylene. Thermoplastic plastics are to be preferred as a matter of principle for manufacturing reasons. The hollow needle can consist of plastic, metal, glass or a ceramic material.

Instead of the annularly extending latching projection 7 shown in a cross section in FIG. 2, an annularly extending recess or groove can be provided. In that case, the hollow needle provided for withdrawing liquid comprises an annularly outwardly protruding latching projection corresponding therewith. If the needle is pushed through the opening of the vessel, then the groove and the recess latch into each other which leads to a liquid-tight connection between the hollow needle and the vessel. Conversely, however, the needle can also be provided with an annular groove into which an annular latching projection of the vessel latches, in order thus to not only provide for a stop, but also to effect a liquid-tight connection at the same time.

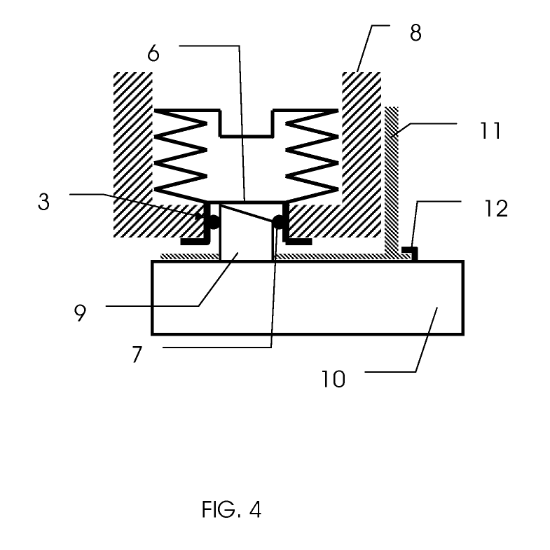

FIG. 4 shows the vessel from FIG. 3 which is retained by retaining means 8 of a device for automatically dispensing (hereinafter referred to as “dispensing device”). The retaining means 8 grip the vessel from the outside in the neck region 3. A hollow needle 9 of a microfluidic system 10 extends into the neck 3. The hollow needle and the microfluidic system are appropriately positioned by positioning means 11 of the dispensing device. To this end, the positioning means grasp around the hollow needle 9. The microsystem can be provided, for example, with a hook 12 which grasps around an end portion of the positioning means 11 for a thus improved positioning.

The dispensing device is configured such that the vessel can be moved in a downward direction until the needle pierces the membrane 6 in order thus to empty the vessel. For example, the retaining means 8 are moved in a downward direction for such a piercing action. The contents of the vessel can thus come into the microsystem. In that case, the latching projection 7 acts as an annular seal and seals the feed from the vessel into the microsystem thus created in such a way that liquid is incapable of escaping to the outside.

Preferably, the dispensing device shown in FIG. 4 is made such that a plurality of vessels can simultaneously be inserted into it and be emptied in a controlled manner.

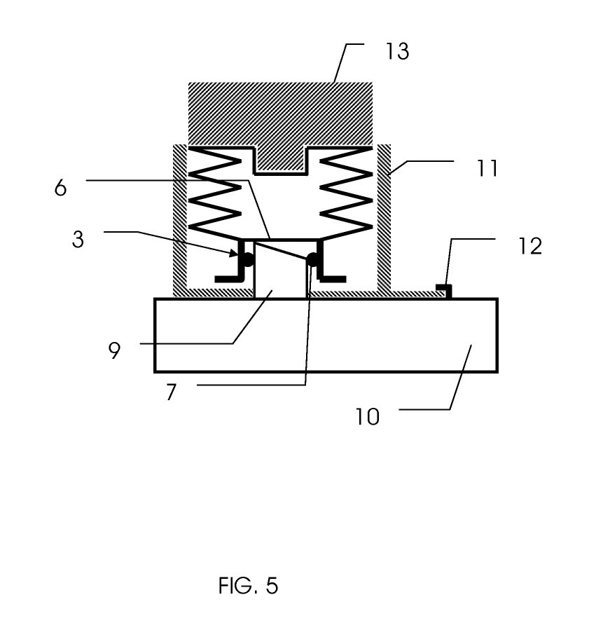

FIG. 5 shows a different embodiment of the dispensing device. In contrast to the embodiment shown in FIG. 4, lateral walls of the positioning means 11 serve for accommodating and guiding the vessel. The lateral walls 11 are adjacent to the vessel as shown in order to be able to hold and guide it. A stamp or bolt 13 of the dispensing device extends into the depression of the bottom of the vessel. By means of the stamp 13, which can be moved in a downward direction, the membrane 6 is pierced first and then the bellows is compressed in order thus to empty the vessel completely.

Since the vessel is very small, lateral walls serving as guiding means are not necessary. They merely facilitate handling. Thus, the stamp 13 already suffices for suitably clamping and moving the vessel.

One special feature of the vessel shown in FIGS. 1, 3 to 5 lies in the fact that first the bellows is manufactured with only one opening region. A closure or lid with a membrane and a flange is placed upon this opening region, as it is shown in FIG. 2. The flange, which is separated from the membrane by a cylindrical wall, is then welded to the flange 4 of the bellows. The closure or lid in particular consists of the same material as the vessel, for example of a thermoplastic plastic in order to be able to simply and cost-effectively weld the vessel to the lid and thus seal it.

The membrane preferably comprises a predetermined breaking point in order to facilitate the opening process.

The membrane is thus shifted into the opening channel duct of the vessel. The cylindrical wall of the lid is preferably dimensioned in such a way that it is pressed against the neck region 3 of the vessel in order to seal the vessel in an improved manner. The cylindrical wall can now serve for guiding the needle as described.

The membrane located in the vessel can also be realized by a foil being glued onto a corresponding cylindrical counter-element and the protruding region of the counter-element being pushed into the opening region of the vessel. There is then a guide for a needle located on the inside. However, the drawback remains that the sealing capacity of the gluing process of the foil is comparatively poor.

1. A system comprising a vessel and a fluid located in the vessel, wherein the vessel is sealed in a fluid-tight manner, wherein the vessel comprises a bellows which is provided with a bottom and sealed with a lid.

2. A system according to claim 1, wherein the vessel is welded shut and thus sealed.

3. A system according to claim 1 wherein the volume of the vessel is no more than two milliliters.

4. A system according to claim 1, wherein the fluid is an alcohol-containing buffer solution.

5. A system according to claim 1, wherein the vessel comprises a bottom region and an opening region separated from the bottom region by said bellows, wherein the bottom region comprises a pin protruding in a direction of the opening region or a depression protruding in the direction of the opening region.

6. A system according to claim 5, wherein the pin or the depression reaches the opening region when the bellows is completely compressed.

7. A system according to claim 1, wherein the vessel comprises an opening region provided with a neck.

8. A system according to claim 7, wherein the neck transitions into a laterally outwardly protruding collar.

9. A system according to claim 1, wherein the vessel is sealed with a lid which comprises a pin extending inside the vessel or a depression extending inside the vessel.

10. A system according to claim 1, wherein a closure of the vessel comprises a depression with an inwardly protruding latching projection located therein or an preferably annular groove or recess.

11. A system according to claim 1, wherein the vessel consists of plastic.

12. A vessel for a system according to claim 1, wherein the vessel is configured as a bellows with a sealed bottom region and an opening region, wherein the vessel volume is no more than 2 ml.

13. A vessel according to claim 12, wherein the vessel consists of plastic.

14. A vessel according to claim 12, wherein the bottom region of the vessel comprises a depression or a pin that extends inside the vessel.

15. A device comprising a vessel or a system according to claim 1, with means for compressing the bellows as well as means for piercing an opening region of the vessel.

16. A device according to claim 15, wherein the means for piercing is a hollow needle.

17. A device according to claim 15, wherein the device comprises a microsystem which can be connected to the vessel in such a way that the liquid can be fed from the vessel into the microsystem.

18. A device according to claim 16, wherein a hollow needle and the opening region of the vessel are provided with sealing means, by means of which a liquid-tight connection is provided between the hollow needle and the vessel when the needle has pierced an opening region of the vessel.

19. A method for filling a vessel according to claim 12, wherein a vessel is filled with a fluid and every opening of the vessel is subsequently welded or glued shut.

20. A method according to claim 19, wherein the vessel with the fluid located therein is stored for at least half a year, in a closed state.
